(19) United States
(12) Patent Application Publication
(10) Pub. No.: US 2024/0069633 A1
(43) Pub. Date: Feb. 29, 2024

(54) FINGER BRAILLE DEVICE

(71) Applicant: Ubitone,INC., Tokyo (JP)

(72) Inventors: Eitaro YAMATSUTA, Tokyo (JP); Koji SATO, Tokyo (JP)

(21) Appl. No.: 18/502,104

(22) Filed: Nov. 6, 2023

Related U.S. Application Data
(63) Continuation-in-part of application No. PCT/JP2022/006932, filed on Feb. 21, 2022.

(30) Foreign Application Priority Data
May 13, 2021 (JP) 2021-081373

(51) Int. Cl. G06F 3/01; G09B 21/00

(52) U.S. Cl. CPC G06F 3/014; G06F 3/016; G09B 21/004

(57) ABSTRACT

A finger-worn type finger-braille device that can be carried at all times in daily life is provided. A wearing side device 3A of the present invention includes an input/output unit 10, a main body unit 50 for receiving a signal from the input/output unit 10 to perform predetermined processing, and a wearing tool 20 which holds the input/output unit 10 and the main body unit 50, and by which the input/output unit 10 and the main body unit 50 are to be worn on a person's hand. The input/output unit 10 is provided on a finger F of the hand by the wearing tool 20, and has a motion detector 13 for detecting the motion of the finger F. The main body unit 50 receives motion information complying with the motion of the finger detected by the motion detector 13 and identifies characters based on the received motion information.

### TECHNICAL FIELD

The present invention relates to a finger-braille device to be used while worn on fingers of a hand.

### BACKGROUND ART

A method called finger-braille is known as one of communication means for visual and auditory disabled people. In the finger-braille, for example, totally six fingers including index fingers, middle fingers, and ring fingers of both hands are used to represent six dots of braille, and an intention of a person is communicated to others by typing braille with the fingers. The finger-braille is basically a method for a visual and auditory disabled person to receive information through an interpreter to communicate with the outside. However, in order to reduce the burden on an interpreter or allow information to be sent and received even when no interpreter is present, there have been proposed some electronic finger-worn type finger-braille devices.

For example, Patent Literature 1 discloses a finger-braille device in which tactile stimulation elements attached to a plurality of fingers apply different tactile stimulations to the corresponding fingers, so that a user can easily perceive which finger is being stimulated. However, in Patent literature 1, a tactile stimulation is applied to a finger with a weight rotated by a drive motor or the like, and thus it is not possible to type finger-braille and convey an intention based on the typed finger-braille to another person. In other words, in Patent literature 1, it is impossible to convey finger-braille bidirectionally between users. On the other hand, Patent Literature 2 discloses a finger-braille device that can bidirectionally convey finger-braille between users.

### CITATION LIST

### Patent Literature

Patent Literature 1: Japanese Patent Laid-Open No. 2002-123169 (FIG. 2, FIG. 3)

Patent Literature 2: Japanese Patent Laid-Open No. 2020-046666 (Second Example, FIG. 9)

### SUMMARY Of INVENTION

### Technical Problem

As disclosed in Patent Literature 1 and Patent Literature 2, the finger-braille device is worn on a person's hand, and the hand is an important part of the human body for the human tactile function. Particularly, the pad of a finger (hereinafter referred to as finger pad) and the palm in the hand are most important for tactile function.

On the other hand, for visual and auditory disabled people, it is necessary for them to have assigned finger-braille devices whenever they wish. However, when they want to convey their intentions to others via the finger-braille devices, they may simultaneously need the tactile function by their finger pads. In this case, the visual and auditory disabled people must once remove their finger-braille devices, which impairs their constant portability. Patent Literature 2 discloses a finger-braille device that can open the finger pads, but in this device, a button (piezoelectric sensor) serving as input means protrudes from the tip of the finger. Therefore, there is a risk that this button becomes an obstacle when the tactile function of the finger pad is required, so that this finger-braille device also needs to be detached.

In view of the above, an object of the present invention is to provide a finger-braille device that is excellent in constant portability in daily life and capable of performing wireless transmission and reception with an external smartphone or personal computer.

### Solution to Problem

A finger-braille device capable of performing wireless transmission and reception with an external smartphone or personal computer (hereinafter also simply referred to as “finger-braille device”) of the present invention comprises: an input/output unit (for example, see input/output units 10, 10A, 10B, and 10C in the present embodiment) for transmitting motion information based on a finger-braille motion signal of each finger, and receiving vibration information related to finger-braille to each finger to transfer vibration to each finger; a main body unit (for example, see main body unit 50 in the present embodiment) for receiving the motion information from the input/output unit to perform predetermined processing, and transmitting the vibration information to the input/output unit; and a wearing tool (for example, see wearing tool 20 in the present embodiment) for wearing the input/output unit on a back side of each finger and wearing the main body unit on a back of a hand.

The input/output unit in the present invention comprises: a transceiver (for example, see a transceiver 15 in the present embodiment) that is provided on a back side of each finger of the hand by the wearing tool, and performs transmission and reception with the main body unit; a motion detector (for example, see a motion detector 13 in the present embodiment) that detects a signal complying with the motion of each finger and transmits the signal as motion information of each finger to the main body unit via the transceiver; and a vibrator (for example, see a vibrator 11 in the present embodiment) that transfers vibration to a assigned finger based on the vibration information received from the main body unit via the transceiver.

The main body unit in the present invention comprises a first transceiver (for example, see a first transceiver 51 in the present embodiment) that performs transmission and reception with the input/output unit, and a second transceiver (for example, see a second transceiver 57 in the present embodiment) that performs wireless transmission and reception with an outside, wherein based on motion information complying with the motion of the finger received via the first transceiver and detected by the motion detector, the main body unit identifies character information regarding finger-braille and/or function information to be executed, wirelessly transmits the character information and/or the function information via the second transceiver to an outside, and transmits vibration information to be assigned to each finger via the first transceiver based on character information regarding finger-braille and command information received from the outside via the second transceiver.

It is preferable that the main body unit in the present invention is provided in advance with association information for associating the motion information with the character information to be identified and/or function information to be executed, collates the motion information received from the first transceiver of the input/output unit with the association information, thereby converting the motion information to and identifying the character information regarding finger-braille and/or function information to be executed, and wirelessly transmits them to an outside by the second transceiver.

In the finger-braille device of the present invention, it is preferable that the output unit includes three input/output units corresponding to an index finger, a middle finger, and a ring finger respectively, and the motion detectors of the three input/output units are arranged on finger back sides of the index finger, the middle finger, and the ring finger, respectively.

In the finger-braille device of the present invention, the preferable motion detectors are arranged between first joints and second joints of the index finger, the middle finger, and the ring finger, respectively.

In the finger-braille device of the present invention, it is preferable that the output unit includes an output unit corresponding to a thumb, and the motion detector of the input/output unit is arranged on a finger back side of the thumb.

In the finger-braille device of the present invention, it is preferable that the motion detector is arranged between a first joint and a second joint of the thumb.

In the finger-braille device of the present invention, it is preferable that the main body unit is provided on a back of the hand by the wearing tool.

In the finger-braille device of the present invention, the preferable wearing tool comprises a first holding portion, a second holding portion and a band.

The first holding portion holds each of the three input/output units, and is fitted onto each of the index finger, the middle finger, and the ring finger.

The second holding portion is continuous with the first holding portion, holds the main body unit, and is provided only on a back side of the hand.

The band is continuous with the second holding portion and wound around a wrist of a person.

When an input/output unit corresponding to a thumb is provided, the first holding portion holds the corresponding input/output unit, and is fitted onto the thumb.

In the finger-braille device of the present invention, the preferable motion detector comprises a three-axis acceleration sensor that detects three-dimensional waveform information of a motion of each finger, and transmits motion information corresponding to the detected three-dimensional waveform information to the first transceiver of the input/output unit, and the transceiver transmits the motion information to the main body unit.

Further, the main body unit preferably transmits, from the first transceiver, vibration information assigned to each finger based on finger-braille information from an outside that is received by the second transceiver of the main body unit, and the vibrator comprises an eccentric vibration motor or a piezoelectric actuator for vibrating each assigned finger based on the vibration information received from the main body unit via the first transceiver of the input/output unit.

Further, in the finger-braille device of the present invention, it is preferable that the input/output unit and the main body unit are worn on each of left and right hands by the wearing tool.

### Advantageous Effects of Invention

According to the finger-braille device of the present invention which is capable of performing wireless transmission and reception with an external smartphone or personal computer, the input/output unit provided on the finger of the hand by the wearing tool includes the motion detector for detecting the motion of each finger, and the vibrator for transferring vibration to each finger based on character information related to finger-braille, etc. Since the motion detector can detect the braille motion of the finger even when it is worn on the finger back side, a finger pad which is important for human tactile function can be opened without being covered by elements of the finger-braille device. Further, the vibrator can transfer vibration as finger-braille to each assigned finger based on character information related to finger-braille, etc. received from an external smartphone or personal computer. As a result, according to the present invention, there is provided a finger-braille device that restrain the need to detach the device to the minimum level, is excellent in constant portability in daily life, and enables a transmission and reception operation of finger-braille.

### BRIEF DESCRIPTION OF DRAWINGS

FIG. 1 is a diagram showing a schematic configuration of a finger-braille system to be used in a finger-braille device according to a first embodiment of the present invention.

FIG. 2 is a diagram showing a schematic configuration of an input/output unit of a wearing side device in FIG. 1.

FIG. 3 is a diagram showing a schematic configuration of a main body unit of the wearing side device in FIG. 1.

FIG. 4 is a diagram showing an example in which the wearing side device of FIG. 1 is worn on a hand when viewed from the back of the hand.

FIG. 5 is a diagram showing an example in which the wearing side device of FIG. 1 is worn on the hand when viewed from the palm side.

FIGS. 6(a) and 6(b) show a first holding portion of a wearing tool in the wearing side device of FIG. 2, where FIG. 6(a) is a plan view and FIG. 6(b) is a front view.

FIGS. 7(a) and 7(b) show a second holding portion of a wearing tool in a finger-braille device of FIG. 2, where FIG. 7(a) is a plan view and FIG. 7(b) is a front view.

FIG. 8 is a diagram showing a schematic configuration of a non-wearing side device of FIG. 1.

FIG. 9 is a diagram showing a schematic configuration of a finger-braille system to be used in a finger-braille device according to a second embodiment of the present invention.

FIG. 10 is an example in which a wearing side device of FIG. 9 is worn on a hand when viewed from the back side of the hand.

FIG. 11 is an example in which the wearing side device of FIG. 9 is worn on the hand when viewed from the palm side.

FIG. 12 is a diagram showing numeric keys and function keys assigned to the left and right hands.

FIG. 13 is a table showing an example of association information stored in advance in a calculator.

### DESCRIPTION OF EMBODIMENTS

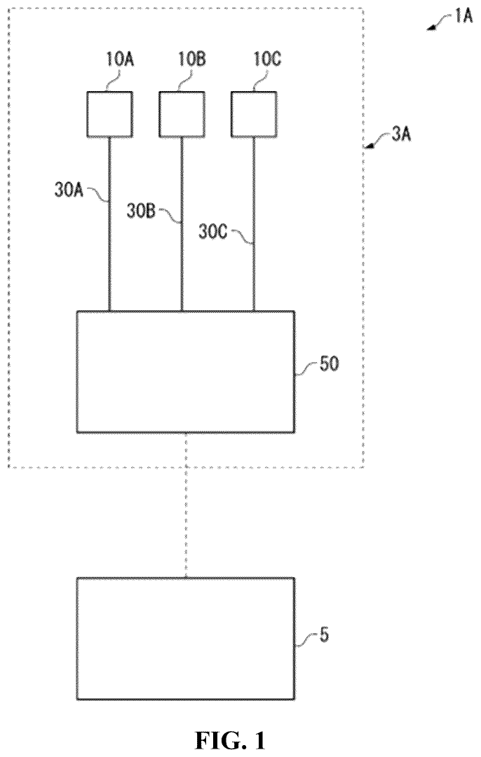

Hereinafter, a finger-braille system 1 to be used in a finger-braille device according to an embodiment of the present invention will be described with reference to the accompanying FIGS. 1 to 13. A finger-braille system 1A to be used in a finger-braille device according to a first embodiment and a finger-braille system 1B to be used in a finger-braille device according to a second embodiment will be described hereunder, and the finger-braille system 1A and the finger-braille system 1B will be referred to as a finger-braille system 1 when they are collectively referred to. Hereinafter, the first embodiment (the finger-braille system 1A to be used in the present finger-braille device) in which finger-braille can be performed with three fingers of one hand, and the second embodiment (the finger-braille system 1B to be used in the present finger-braille device) in which finger-braille can be performed with four fingers of one hand will be sequentially described in this order.

[First Embodiment: FIGS. 1 to 8]

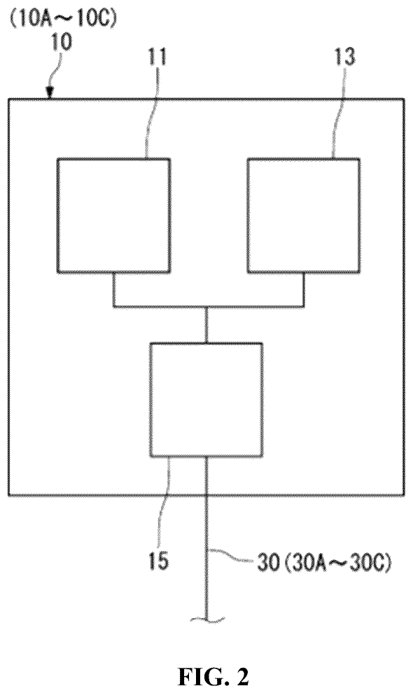

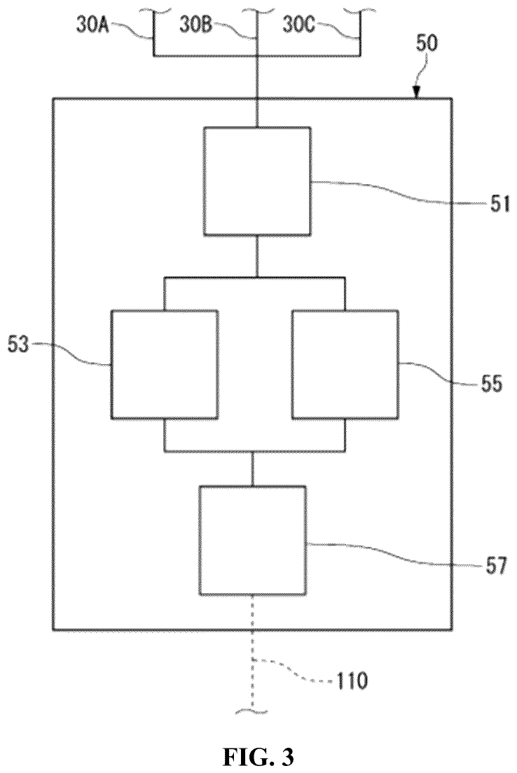

As shown in FIG. 1, the finger-braille system 1A includes a wearing side device 3A to be used while a visual and auditory disabled person wears the wearing side device 3A on his/her hand, and a non-wearing side device 5 that does not take part in the wearing on the hand of the visual and auditory disabled person. The wearing side device 3A of the finger-braille system 1A has constant portability that can reduce the frequency at which the visual and auditory disabled person detaches the wearing side device 3A in daily life. This constant portability is achieved by opening the finger pads of the hand on which the wearing side device 3A is worn such that the finger pads are not covered by the wearing side device 3A. Furthermore, this constant portability is achieved by opening the palm of the hand on which the wearing side device 3A is worn such that the palm of the hand is not covered by the wearing side device 3A.

[Wearing Side Device 3A: FIG. 1, FIG. 2, FIG. 3]

The wearing side device 3A will be described with reference to FIG. 1, FIG. 2, and FIG. 3. Note that the wearing side device 3A corresponds to the finger-braille device of the present invention, and the finger-braille device of the present invention is intended for a transmission function of the wearing side device 3A.

[Function of Wearing Side Device 3A]

The wearing side device 3A has an information receiving function and an information transmitting function based on a person on which the wearing side device 3A is worn.

The receiving function allows a wearer to receive information through the wearer's finger upon vibration of a vibrator 11. In the receiving function, information regarding finger-braille is sent from the non-wearing side device 5 to the wearing side device 3A, and the vibrator 11 vibrates based on this information. Further, the transmitting function transmits information as a signal that is detected by a motion detector 13 when the wearer moves his/her finger for finger-braille. In the transmitting function, information regarding finger-braille is sent from the wearing side device 3A to the non-wearing side device 5.

[Configuration of Wearing Side Device 3A]

As shown in FIG. 1, the wearing side device 3A includes three input/output units 10A, 10B, and 10C, a main body unit 50 for receiving and transmitting signals from and to the input/output units 10A, 10B, and 10C, and signal cables 30A, 30B, and 30C for connecting the input/output units 10A, 10B, and 10C to the main body unit 50, respectively. The wearing side device 3A is worn on each of both left and right hands, and the input/output units 10A, 10B, and 10C are attached to the index finger, middle finger, and ring finger of each hand, respectively.

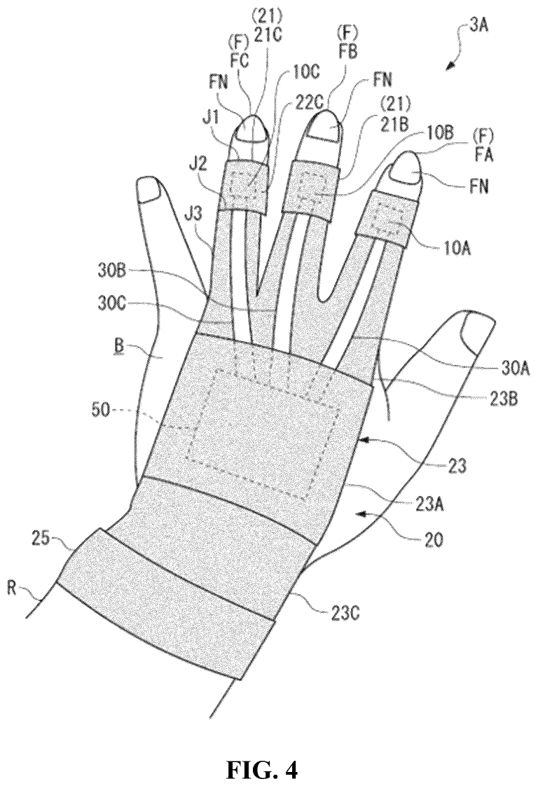

Detailed description will be made later with reference to FIG. 4, but although the wearing side device 3A is attached to the wearer's hand, it does not interfere with the use of the finger pads. This is one of requirements for constant portability. In the following description, the input/output units 10A, 10B, and 10C may be collectively referred to as an input/output unit 10, and the signal cables 30A, 30B, and 30C may be collectively referred to as a signal cable 30.

[Configuration of Input/Output Unit 10: FIG. 2]

As shown in FIG. 2, the input/output unit 10 (10A, 10B, 10C) includes a vibrator 11 for implementing the receiving function, and a motion detector 13 for implementing the transmitting function. The input/output unit 10 includes a transceiver 15 for receiving an electrical signal from the non-wearing side device 5 and transmitting it to the vibrator 11, and receives an acceleration detected by the motion detector 13 and transmits it to the non-wearing side device 5.

Note that the vibrator 11, the motion detector 13, and the transceiver 15 are only the minimum configurations of each input/output unit 10, and the input/output unit 10 can include other components. For example, the input/output unit 10 may further include hardware such as a circuit correction mechanism for allowing these minimum configurations to operate without malfunction, and lighting equipment such as LED (Light Emitting Diode) which blinks when receiving or transmitting information.

[Vibrator 11: Receiving Function]

The receiving function of the vibrator 11 provides electronic braille information to a wearer in the form of vibration. The vibrator 11 includes, for example, a device that vibrates based on electronic information such as an eccentric vibration motor or a piezoelectric actuator. The electronic braille information is received by the vibrator 11 from the main body unit 50 via the transceiver 15.

When the wearing side devices 3 are attached to both the right and left hands of the wearer, the vibrator 11 is attached to each of totally six fingers of the index fingers, middle fingers, and ring fingers of both the right and left hands, so that vibrations can be transmitted to the six fingers. Specifically, by combining the presence or absence of vibration for each finger among the six fingers, the wearer can receive finger-braille information pieces of the sixth power of 2, that is, 64 types of finger-braille information pieces. These 64 types of finger-braille signals can be easily converted into multiple languages using character-to-braille conversion correspondence tables which are uniquely defined in many countries around the world.

[Motion Detector 13: Transmitting Function]

In the transmitting function of the motion detector 13, the wearer makes his/her intended motion as finger-braille information using a fingertip, this motion is detected as a three-dimensional waveform by the motion detector 13, and an electrical signal corresponding to the detected three-dimensional waveform is transmitted to the main body unit 50 via the signal cable 30. The motion detector 13 is typically configured by a three-dimensional acceleration sensor. When the wearing side devices 3A are attached to both the right and left hands of the wearer, the transmitting function is executed for each of the six fingers. The motion detector 13 is one of the requirements for the wearing side device 3A to have constant portability.

[Main Body Unit 50: FIG. 1 and FIG. 3]

As shown in FIG. 1, the main body unit 50 is connected to the input/output unit 10 via the signal cable 30, and takes charge of transmission of information to the input/output unit 10 and reception of information from the input/output unit 10. In order to implement this function, as shown in FIG. 3, the main body unit 50 includes a first transceiver 51 that takes charge of transmission and reception of information to and from the input/output unit 10 of the wearing side device 3A, and a second transceiver 57 that takes charge of transmission and reception of information to and from the non-wearing side device 5. Further, a calculator 53 for executing calculations necessary for the receiving function and the transmitting function is provided between the first transceiver 51 and the second transceiver 57. Further, a command unit 55 is provided which issues command information to the input/output unit 10 via the signal cable 30 or issues command information to the non-wearing side device 5 via a radio communication 110, for example, Bluetooth (registered trademark) based on a calculation result by the calculator 53.

The main body unit 50 includes CPU (Central Processing Unit) that executes a program, ROM (Read Only Memory) that stores programs and fixed information, and RAM (Read Only Memory) that serves as a work memory that develops programs and information for execution by the CPU. The same applies to the non-wearing side device 5 described later.

The first transceiver 51, the calculator 53, the command unit 55, and the second transceiver 57 are only the minimum configurations in each main body unit 50, and the main body unit 50 can have other configurations. For example, the main body unit 50 may include a power supply mechanism for supplying electric power to the main body unit 50 and the input/output unit 10, hardware such as a circuit correction mechanism for enabling these minimum configurations to operate without malfunction, and a lamp such as an LED that blinks when receiving or transmitting information. The same also applies to the non-wearing side device 5 described later.

Further, the calculator 53 calculates and processes information regarding the transmitting function as follows.

The calculator 53 processes three-dimensional waveform information transmitted from the motion detector 13 of the input/output unit 10, thereby converting the three-dimensional waveform information into electronic character information regarding the corresponding finger-braille. The converted character information is transferred to the non-wearing side device 5 via the second transceiver 57, and displayed as characters on the non-wearing side device 5.

Since the wearing side devices 3A are attached to both the left and right hands, six types of three-dimensional waveform information corresponding to six fingers are sent to the calculator 53, and the calculator 53 performs calculation processing on the six types of three-dimensional waveform information, thereby creating 64 types of character information.

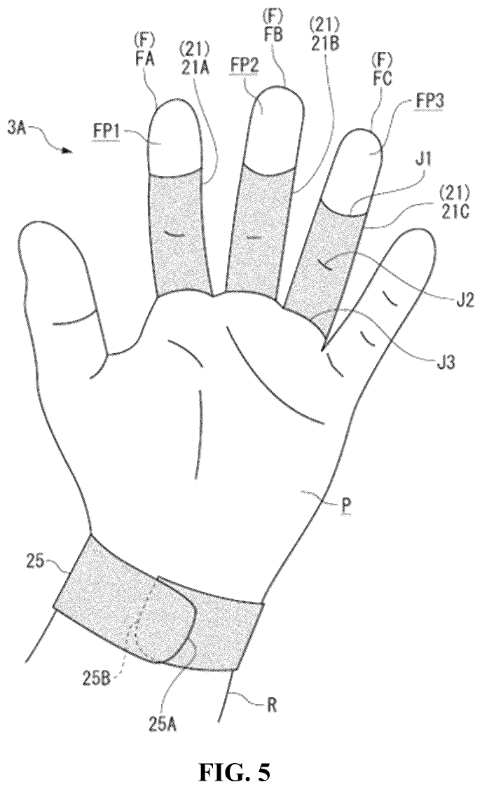

A specific example of a braille operation by the main body unit 50 will be described in a second embodiment.

[Wearing Example of Wearing Side Device 3A: FIG. 4 and FIG. 5]

Next, an example in which the wearing side device 3A is worn on the hand will be described with reference to FIGS. 4 and 5.

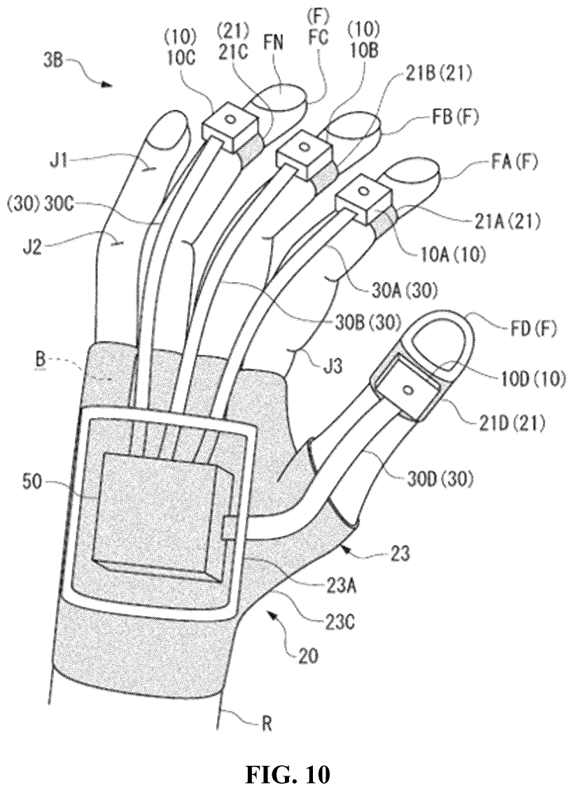

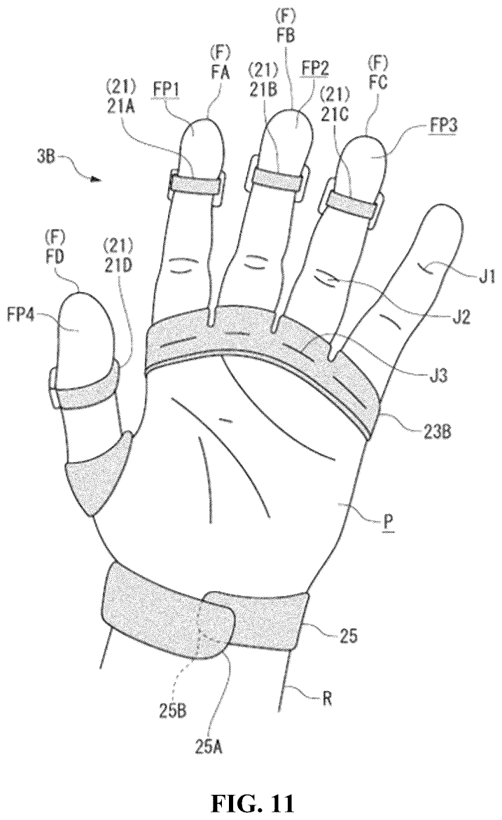

As shown in FIGS. 4 and 5, the wearing side device 3A includes a wearing tool 20 for wearing the input/output unit 10, the signal cable 30, and the main body unit 50 on a person's hand. The input/output unit 10, the signal cable 30, and the main body unit 50 are worn on the person's hand by the wearing tool 20 while being held by the wearing tool 20. In FIGS. 4 and 5, the wearing tool 20 that covers the person's hand is shown in gray, but this is to clearly distinguish the wearing tool 20 from the person's hand, and does not represent the color of the wearing tool 20. The same applies to FIGS. 10 and 11 of the second embodiment.

The wearing tool 20 opens fingertip sides of three fingers to be worn beyond the first joints of the three fingers, and also opens the palm side. The configuration of this wearing tool 20 is one of the requirements for the wearing side device 3A to have constant portability as described in detail later.

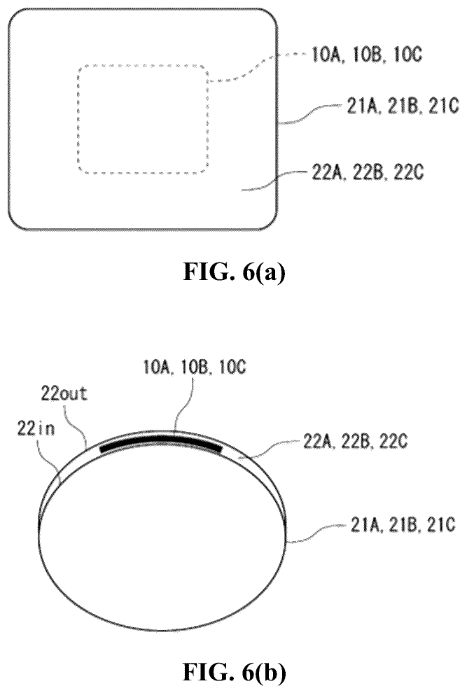

The wearing tool 20 holds the input/output unit 10, and also includes a first holding portion 21 to be attached to fingers F, a second holding portion 23 that holds the main body unit 50 and corresponds to the back B of the hand, and a band 25 which is continuous with the second holding portion 23 and wound around the wrist R.

[First Holding Portion 21: FIG. 4, FIG. 5, and FIGS. 6(a) and 6(b)]

As shown in FIG. 4 and FIG. 5, the first holding portion 21 includes first holding portions 21A, 21B, and 21C corresponding to the index finger FA, the middle finger FB, and the ring finger FC, respectively. The first holding portions 21A, 21B, and 21C each have a cylindrical or sheath-like structure so as to be fitted around the index finger FA, the middle finger FB, and the ring finger FC.

As shown in FIG. 4, on the back B side of the hand, the first holding portions 21A, 21B, and 21C cover the ranges extending from the first joints J1 to the second joints J2 of the index finger FA, the middle finger FB, and the ring finger FC, respectively. Furthermore, as shown in FIG. 5, on the palm P side, the first holding portions 21A, 21B, and 21C cover the ranges extending from the first joints J1 through the second joints J2 up to the third joints J3 of the index finger FA, the middle finger FB, and the ring finger FC, respectively. Therefore, even in a state where the wearing tool 20 is worn, the tip sides of the index finger FA, middle finger FB, and ring finger FC beyond the first joints J1 thereof are not covered by the first holding portions 21A, 21B, and 21C, so that they are opened. In particular, finger pads FP1, FP2, and FP3 at the tip sides beyond the respective first joints J1 are opened.

As shown in FIG. 4 and FIGS. 6(a) and 6(b), the first holding portions 21A, 21B, and 21C are provided with pockets 22A, 22B, and 22C on respective fingernail FN sides. The input/output units 10A, 10B, 10C are accommodated in the respective pockets 22A, 22B, 22C. As shown in FIG. 6(b), each of the pockets 22A, 22B, and 22C has a two-layer structure including an inner layer 22ᵢₙ and an outer layer 22ₒᵤₜ on the fingernail FN side, that is, the finger back side. The pocket having this two-layer structure also applies to the second holding portion 23 described next. However, the pockets as means for accommodating and holding the input/output units 10A, 10B, 10C are just an example, and other means of attaching the input/output units 10A, 10B and 10C to the first holding portions 21A, 21B and 21C by hook-and-loop fasteners or the like may be adopted.

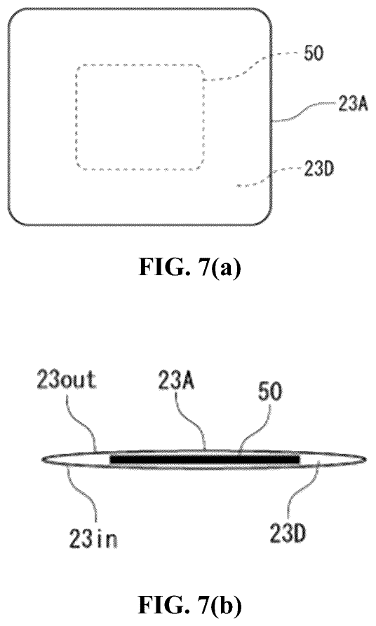

Here, when finger-braille information is output, in order for the wearer's brain to determine that each of the three fingers represents an independent signal, it is preferable that vibration is received at a position which is as close to the tip of the finger as possible. Therefore, as described above, it is preferable that each of the input/output units 10A, 10B, and 10C is provided between the first joint J1 and the second joint J2.

[Second Holding Portion 23: FIG. 4, FIG. 5, FIGS. 7(a) and 7(b)]

Next, as shown in FIG. 4 and FIG. 5, the second holding portion 23 is provided on the back B side of the person's hand and holds the main body unit 50.

As shown in FIG. 4, the second holding portion 23 includes a holding portion 23A for holding the main body unit 50, a first connecting portion 23B for connecting the holding portion 23A and the first holding portions 21A, 21B, and 21C, and a second connecting portion 23C for connecting the holding portion 23A and the band 25. As shown in FIG. 4, the second holding portion 23 is supported by the first holding portions 21A, 21B, 21C and the band 25, whereby the second holding portion 23 is provided on the back B side of the hand. However, the second holding portion 23 itself is not fixed to the back B of the hand, and the palm P is opened as shown in FIG. 5.

As shown in FIGS. 7(a) and 7(b), the holding portion 23A includes an inner layer 23ᵢₙ provided on the back B side of a person's hand when the second holding portion 23 is worn on the hand, and an outer layer 23ₒᵤₜ facing the inner layer 23ᵢₙ. The space between the inner layer 23ᵢₙ and the outer layer 23ₒᵤₜ constitutes a pocket 23D for accommodating the main body unit 50. The main body unit 50 can be fixed to one or both of the inner layer 23ᵢₙ and the outer layer 23ₒᵤₜ, for example, with a hook-and-loop fastener, in order to restrict the positional movement of the main body unit 50 inside the pocket 23D. Further, the insides of the inner layer 23ᵢₙ and the outer layer 23ₒᵤₜ can be sealed by sewing the peripheries thereof or the like.

As shown in FIGS. 4 and 5, the first connecting portion 23B covers the back B side of the hand while connecting the holding portion 23A and the first holding portions 21A, 21B, and 21C. Further, the first connecting portion 23B covers the index finger FA, the middle finger FB, and the ring finger FC on the palm P side.

[Band 25: FIG. 4 and FIG. 5]

Next, as shown in FIG. 4 and FIG. 5, the band 25 is wound around the person's wrist R, thereby fixing the wearing tool 20 to the person's hand. The band 25 is a band-shaped member, and as shown in FIG. 5, both end portions 25A and 25B thereof are provided with, for example, hook-and-loop fasteners, and one end portion 25A and the other end portion 25B are joined to each other, whereby they are fixed to the person's wrist R.

[Relation Between Wearing State of Wearing Tool 20 and Person's Hand: FIG. 4 and FIG. 5]

The wearing tool 20 is worn on a person's hand. However, as shown in FIG. 5, the tip sides of the index finger FA, the middle finger FB, and the ring finger FC beyond the first joints J1 thereof, particularly, the three finger pads FP1, FP2, and FP3 thereof are not covered by the wearing tool 20, but are opened. Furthermore, as shown in FIG. 5, the palm P is not covered by the wearing tool 20, and is opened.

[Material of Wearing Tool 20]

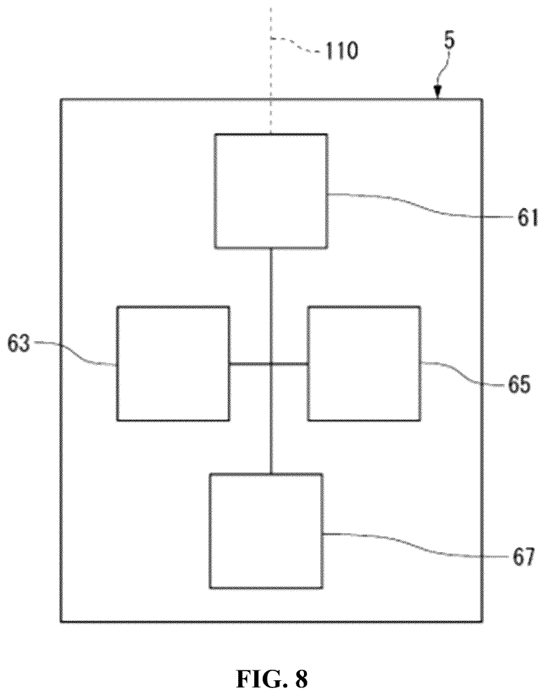

Although the material constituting the wearing tool 20 is arbitrary, it is preferable that it is made of a material such as chemical fiber having excellent elasticity in order to reduce the burden on the motions of the hands of a person who is wearing the wearing tool 20. In particular, it is preferable that this material has a quick drying property. This quick drying property includes, for example, antibacterial polyester, which has quick water penetration, diffusion, and drying properties. However, the quick drying property in the present invention is not limited to this style, and may include materials that are difficult for water to penetrate, such as metal materials and plastic materials.

[Non-Wearing Side Device 5: FIG. 8]

Next, the non-wearing side device 5 will be described with reference to FIG. 8. A computer device, more specifically a smartphone, a tablet terminal or the like is applied as the non-wearing side device 5.

The non-wearing side device 5 includes a transceiver 61 which takes charge of transmitting and receiving information to and from the main body unit 50 of the wearing side device 3A, an input unit 63 for inputting finger-braille information to the wearing side device 3A, and a display unit 65 for displaying finger-braille information received from the wearing side device 3A and the finger-braille information input from the input unit 63. Further, the non-wearing side device 5 also includes a controller 67 for controlling the operations of the transceiver 61, the input unit 63, and the display unit 65.

In the case of application to a smartphone, the input unit 63 corresponds to input keys, and the display unit 65 corresponds to an LCD (Liquid Crystal Display).

[Effects of Finger-Braille System 1A]

In the finger-braille system 1A, the wearing side device 3A to be worn on a person's hand has the following effects.

[First Effect: Effect Caused by Finger Pads and Palms Being Opened]

In the wearing side device 3A, the three finger pads FP1, FP2, FP3 and the palm P are opened. As a result, the wearing side device 3A has constant portability. In other words, the tactile functions of finger pads and palms are very important for visual and auditory disabled people in order for the people to have the same daily life as non-disabled people. In particular, the finger pads up to the first joints have the most important tactile function, and even in a state where the wearing side device 3A is worn, the tactile function is not hindered if the skin in this area is opened. Here, the finger pads FP1, FP2, and FP3 and the palm P may be collectively referred to as finger pads, etc. in the following description.

In addition to the above-mentioned tactile function, the effect caused by the finger pads, etc. being not covered by the wearing tool 20 is effective in preventing infectious viruses and bacteria. In other words, the finger pads, etc. can be selectively washed or disinfected even while the wearing side device 3A is being worn. Just like non-disabled people, visual and auditory disabled people need to wash or disinfect their hands frequently when engaging in public activities in order to prevent them from infect others with viruses and bacteria and protect themselves from viruses and bacteria. Nowadays, it is a routine activity for people to wash their fingers several times or more a day, and it contributes to constant portability that the fingers can be washed, etc. while wearing the wearing side device 3A.

In particular, as long as the wearing side device 3A is formed of a material having a quick drying property, even if the material constituting the wearing tool 20 becomes moist due to washing or the like, it will be quickly dried, which makes it possible to prevent the growth of infectious viruses and bacteria.

[Second Effect: Effect Caused by Adopting Motion Detector 13]

By adopting a three-axis acceleration sensor as an example of the motion detector 13, the wearing side device 3A can detect finger-braille motions of the index finger FA, the middle finger FB, and the ring finger FC in a state where the three finger pads FP1, FP2, and FP3 are opened. For example, when a piezoelectric sensor disclosed in Patent Literature 2 is used, it is necessary to provide the piezoelectric sensor on the finger pad side in order to detect braille motion. Therefore, if a piezoelectric sensor is used, it is not possible to open the finger pad, which restricts the tactile function.

Furthermore, since a multi-axis acceleration sensor such as a three-axis acceleration sensor is used to input finger-braille information from the wearer's perspective, in addition to reading dots, it also copes with reading three-dimensional waveforms, that is, conversion of sign language information into characters, thereby achieving an effect of making it easier to transmit character information as compared with conventional finger-braille information input/output devices.

### EXAMPLE 1

Actual input/output work was performed by using the finger-braille system 1A for visual and auditory disabled people.

Here, an eccentric vibration motor was used as the vibrator 11 of the input/output unit 10, and a three-dimensional acceleration sensor capable of reading a three-dimensional waveform was used as the motion detector 13. An LED light that turns on when receiving or transmitting information is incorporated into the input/output unit 10, and the main body unit 50 is provided with an LED light that interlocks with the remaining amount of a power supply. Bluetooth (registered trademark) was used as a wireless medium for the interlocking between the main body unit 50 and the non-wearing side device 5.

Unique software was designed and installed as application software in the non-wearing side device 5, and a lithium ion battery capable of operating for 24 hours was used. Further, each of the input/output unit 10 and the main body unit 50 is configured by a housing formed of resin by a 3D printer, and they were configured to have a waterproof structure together with an electric cable for connecting them. There was used a circuit having a structure in which only two electrodes are opened to the main body unit 50 side, the circuit being enabled to be supplied with electric power from an external power supply. In addition, the wearing tool 20 was made by sewing an antibacterial polyester fabric that was excellent in elasticity, hydrophilia, and quick-drying property.

### EXAMPLE 2

A visual and auditory disabled person who has learned finger-braille wore the wearing side device 3A, and conducted a signal reception experiment. Five hundreds of daily Japanese conversation sentences such as “Hello” and “Thank you” were selected and imported into the non-wearing side device 5. This information group was transmitted as the finger-braille information, and it was revealed that information could be transmitted while any sentence could be correctly understood by the wearer. Next, the wearer input finger-braille by tapping on the desk, which was then read through the device and displayed as text information on the screen of a smartphone. As a result of the 15-minute experiment, all words and sentences were converted into text information as intended by the wearer.

### EXAMPLE 3

Next, a plurality of character information pieces and input work information pieces based on physical motions mainly using the fingertips were defined as sign language, and the input work was simplified through learning by the wearer of the wearing side device 3A.

Specifically, three-dimensional waveforms corresponding to text information pieces to be frequently used, such as “yes”, “no”, “thank you”, and “hello”, and input work information pieces to be frequently used, such as “delete one character”, “confirm input text with finger-braille output”, and “confirm sentence and transmit information” were defined as sign language, and the wearer was requested to repetitively learn and then memorize the sign language. At the same time, the reading accuracy was enhanced on the wearing side device 3A side by a machine learning function.

After enhancing the wearer's understanding and the device's functionality up to a sufficiently practical level, the wearer executes an output operation of text information pieces through these sign language motions. As a result, it was found that the workability of the wearer was shortened by about several seconds to one minute per motion, and that the finger-braille system 1A could be used with practicality in daily use by visual and auditory disabled people.

### EXAMPLE 4

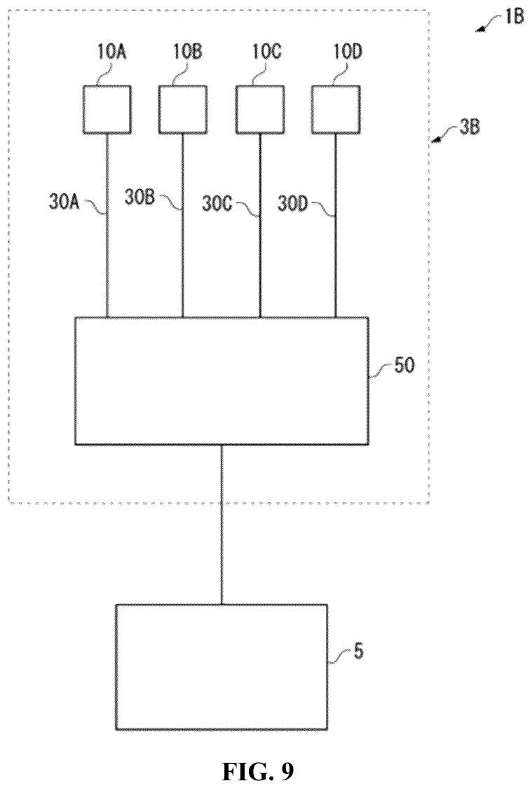

A plurality of visual and auditory disabled persons were requested to experience repeated use of the wearing side device 3A in daily life. It has been favorably received because it allowed wearers to disinfect their palms, read Braille, and touch handrails while wearing the wearing side devices 3A, which allowed them to continue their daily lives with no change while transmitting and receiving more information. It was also confirmed that the wearing side devices 3A also operated without failure due to its everyday waterproof function.

[Second Embodiment: FIG. 9 to FIG. 11]

Next, a finger-braille system 1B according to a second embodiment will be described with reference to FIGS. 9 to 11. The finger-braille system 1A is based on the assumption that the three fingers of the index finger, the middle finger, and the ring finger are used for one hand, but the finger-braille system 1B is based on the assumption that four fingers including the above three fingers and the thumb are used. In other words, the finger-braille system 1B adds the thumb for the operation of a smartphone, and gives a function as a function key to the operation of the thumb, for example. Note that the finger-braille system 1B includes common portions with the finger-braille system 1A. Therefore, in the following description, the same configurations as the finger-braille system 1A are given the same reference signs as the finger-braille system 1A, and the finger-braille system 1B will be described while focusing on the differences from the finger-braille system 1A.

[Overall Configuration of Finger-Braille System 1B: FIG. 9]

As shown in FIG. 9, the finger-braille system 1B includes a wearing side device 3B that is used while a visual and auditory disabled person wears it on his/her hand, and a non-wearing side device 5 that does not touch on the wearing on the hand of the visual and auditory disabled person. The finger-braille system 1B has constant portability like the finger-braille system 1A. The wearing side device 3B of the finger-braille system 1B includes an input/output unit 10D in addition to the input/output units 10A, 10B, and 10C of the wearing side device 3A.

[Function and Configuration of Wearing Side Device 3B: FIG. 9]

Like the wearing side device 3A, the wearing side device 3B has an information receiving function and an information transmitting function based on the wearer.

As shown in FIG. 9, the wearing side device 3B includes four input/output units 10A, 10B, 10C, and 10D, a main body unit 50 that transmits and receives signals to and from the input/output units 10A, 10B, 10C, and 10D, and signal cables 30A, 30B, 30C, and 30D for connecting the input/output units 10A, 10B, 10C, and 10D to the main body unit 50, respectively. The wearing side device 3B is worn on each of both left and right hands, and as an example, the input/output units 10A, 10B, 10C, and 10D are attached to the index finger, the middle finger, the ring finger, and the thumb respectively in each hand. The wearing side device 3B is also attached to the wearer's hand, but the respective finger pads of the fingers are opened, so that there is no problem in using the finger pads.

[Configuration of Input/Output Unit 10]

Although not shown in the figure, the input/output unit 10 (10A, 10B, 10C, 10D) of the wearing side device 3B includes a vibrator 11, a motion detector 13, and a transceiver 15 like the input/output unit 10 of the first embodiment. The functions and configurations of the vibrator 11, the motion detector 13, and the transceiver 15 are also similar to those in the first embodiment described above.

However, the wearing side device 3B targets four fingers of one hand. Therefore, when the wearing side devices 3B are worn on both the left and right hands of the wearer, the vibrator 11 is attached to each of totally eight fingers of the thumbs, index fingers, middle fingers, and ring fingers of the left and right hands, so that vibrations can be transmitted to totally eight fingers. Specifically, by combining the presence or absence of vibration for each finger among the eight fingers, combinations of the eighth power of 2, that is, 256 combinations can be expressed. In addition to character information, inputs of various command keys and combinations thereof to be used for input/output of a digital terminal can be assigned.

[Main Body Unit 50: FIG. 9]

As in the first embodiment, the main body unit 50 is connected to the input/output unit 10 (10A to 10D) via the signal cable 30 (30A to 30D), and takes charge of transmitting information to the input/output unit 10 and receiving information from the input/output unit 10. In order to implement this function, the main body unit 50 includes a first transceiver 51, a calculator 53, a command unit 55, and a second transceiver 57 as described above with reference to FIG. 3.

Since the wearing side devices 3B are attached to both the left and right hands, 256 types of three-dimensional waveform information corresponding to eight fingers are transmitted to the calculator 53, and the calculator 53 performs calculation processing on the 256 types of three-dimensional waveform information to generate information on characters and commands corresponding to the combinations of the 256 types of waveform information. This three-dimensional information is based on the motion of each finger detected by the motion detector 13 of the input/output unit 10 provided on each finger, for example, a motion simulating key-pushing, and is sent to the main body unit 50 via the transceiver 15. The motion simulating key-pushing is hereinafter abbreviated as a touch motion. An example of specific processing regarding Braille by the calculator 53 will be described later.

[Wearing Example of Wearing Side Device 3B: FIG. 10 and FIG. 11]

Next, an example in which the wearing side device 3B is worn on the hand will be described with reference to FIGS. 10 and 11.

Like the wearing side device 3A, the wearing side device 3B includes an input/output unit 10 and a wearing tool 20, and the input/output unit 10, the signal cable 30, and the main body unit 50 are worn on a person's hand by the wearing tool 20 while held by the wearing tool 20.

The function and configuration of the wearing tool 20 (a first holding portion 21, a second holding portion 23, a band 25) are basically the same as those of the first embodiment. However, as shown in FIGS. 10 and 11, the first holding portion 21 has a first holding portion 21D corresponding to the thumb FD in addition to the first holding portions 21A, 21B, and 21C corresponding to the index finger FA, the middle finger FB, and the ring finger FC, respectively.

The first holding portions 21A, 21B, 21C, and 21D each have a ring-like shape that covers the vicinity of the first joint J1 of the thumb FD from the periphery thereof. Therefore, even in a state where the wearing tool 20 is worn, the finger pads FP1 to FP4 at the tip portions beyond the first joints J1 of the index finger FA, the middle finger FB, the ring finger FC, and the thumb FD are opened.

The ring-shaped first holding portions 21A to 21D in the wearing side device 3B do not have the pocket 22D equipped in the wearing side device 3A, and the input/output units 10A to 10D are fixed on the back B side of the hand.

[Second Holding Portion 23, Band 25: FIG. 10 and FIG. 11]

Next, as shown in FIGS. 10 and 11, a second holding portion 23 provided on the back B side of a person's hand is the same as that of the first embodiment in that it includes a holding portion 23A, a first connecting portion 23B, and a second connecting portion 23C, and has the same function as that of the first embodiment.

Similarly to the first embodiment, the band 25 is also wound around a person's wrist R, and both end portions 25A and 25B thereof are joined to each other.

[Non-Wearing Side Device 5: FIG. 8]

As in the first embodiment, a computer device such as a smartphone, a tablet, or the like is applied to the non-wearing side device 5, and as shown in FIG. 8, the non-wearing side device 5 also includes a transceiver 61, an input unit 63, and a display unit 65 for displaying finger-braille information. Further, the non-wearing side device 5 includes a controller 67 for controlling the operations of the transceiver 61, the input unit 63, and the display unit 65.

[Example of Finger-Braille]

An example in which finger-braille is executed using the finger-braille system 1B according to the second embodiment will be described below.

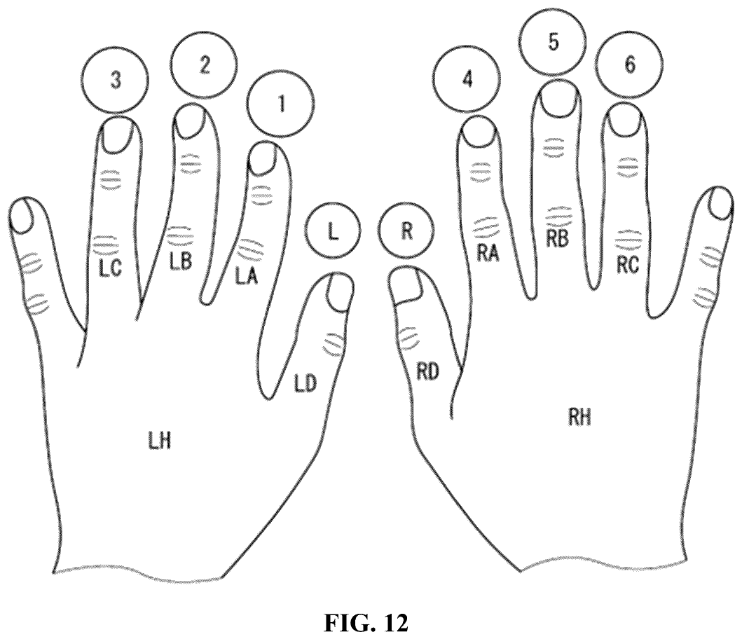

As is well known, a publicly known braille keyboard assigns numbers of six points of Braille to the fingers of both hands. Specifically, as shown in FIG. 12, numbers 1, 2, and 3 are assigned in this order to the index finger LA, middle finger LB, and ring finger LC of the left hand LH, and numbers 4, 5, and 6 are assigned in this order to the index finger RA, middle finger RB, and ring finger RC of the right hand RH. These are called numeric keys, and in this embodiment, numeric keys are likewise assigned. In the second embodiment, as shown in FIG. 12, L and R as function keys (functional keys) are provided on the thumb LD of the left hand LH and the thumb RD of the right hand RH, respectively.

Although not shown in FIG. 12, the index finger LA, the middle finger LB, the ring finger LC, and the thumb LD are provided with the aforementioned input/output units 10A, 10B, 10C, and 10D respectively as well as the index finger RA, the middle finger RB, the ring finger RC, and the thumb RD. Each input/output unit 10 (10A, 10B, 10C, 10D) is provided with a motion detector 13, and when touch motions of the respective fingers are detected by the motion detectors 13, information pieces corresponding to the touch motions are transmitted to the main body unit 50 via the transceiver 15. The information pieces corresponding to the touch operations include information pieces regarding the numeric keys and the function keys assigned to the respective fingers. For example, the information piece corresponding to the touch operation of the index finger LA includes the numeric key 1, and the information piece corresponding to the touch operation of the thumb RD includes the function key R.

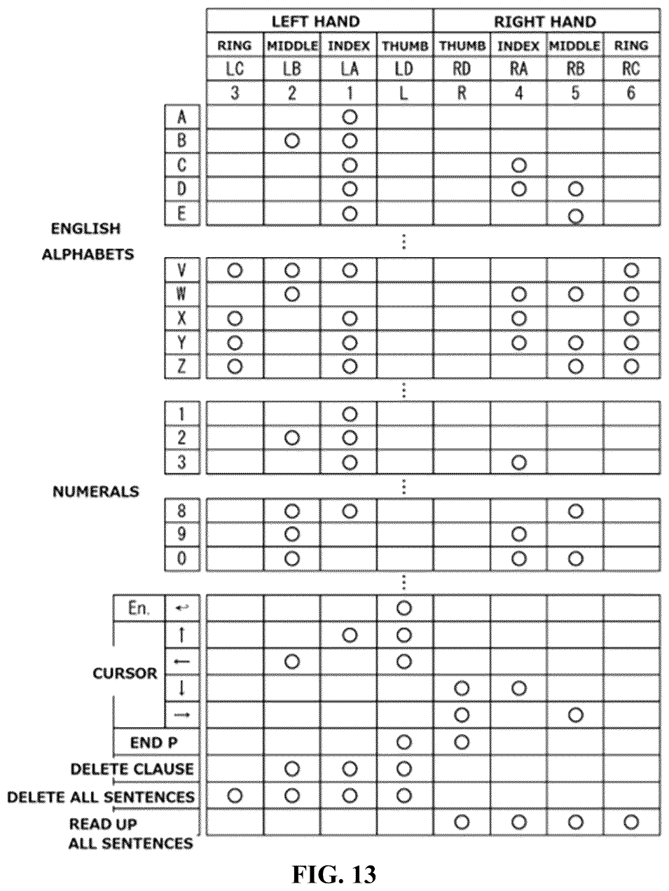

The calculator 53 of the main body unit 50 receives information (motion information) corresponding to the touch motion via the first transceiver 51. The calculator 53 performs character identification processing and other processing in the finger-braille system 1B based on the received motion information. In order to perform this processing, the calculator 53 is enabled to identify the numeric keys and the function keys, and also includes information (association information) for associating the identified numeric keys and function keys with characters (hiragana) and the functions to be executed. An example of the association information is shown in FIG. 13. A processing example in the calculator 53 will be described with reference to FIG. 13. As shown in FIG. 13, the association information includes English alphabets, numbers, etc., but may also include other association information such as Japanese hiragana and other languages.

For example, regarding the English alphabets, when receiving numeric key 1 (index finger LA) and numeric key 2 (middle finger LB) as motion information pieces, the calculator 53 collates them with the association information to identify an English alphabet “B”. Likewise, when receiving numeric key 2 (middle finger LB), numeric key 4 (index finger RA), 5 (middle finger RB), and 6 (ring finger RC) as motion information pieces, the calculator 53 collates them with the association information to identify an English alphabet “W”. Note that in the processing on the English alphabets, the calculator 53 is set to a mode corresponding to the English alphabets.

The identified character information is transmitted to the non-wearing side device 5 via the second transceiver 57 and displayed on the display unit 65 thereof. The character identification up to the foregoing processing can also be performed in the first embodiment, but the following processing based on motion information which also includes the function keys can be performed in the second embodiment.

Next, a case where a number is identified will be described. When the calculator 53 receives the numeric key 1 (index finger LA) as motion information, the numeral “1” is identified by collating it with the association information. Likewise, when receiving the numeric key 2 (middle finger LB) and the numeric key 4 (index finger RA) as motion information, the calculator 53 identifies the numeral “9” by collating them with the association information. Note that when numerals are processed, the calculator 53 is set to a mode corresponding to the English alphabets.

When receiving the function key L (thumb LD) as motion information, the calculator 53 identifies Enter (En.) by collating it with the association information. This identification of Enter is equivalent to pushing the Enter key on a personal computer.

Another example is related to cursor keys, and when receiving an L key (thumb LD) and the numeric key 1 as motion information, the calculator 53 identifies that an upward cursor is pushed. The calculator 53 can also identify leftward, downward, and rightward cursors.

In addition, when receiving the function key L (thumb LD) and the function key R (thumb RD), the calculator 53 identifies and executes the end of the program (end P). Further, when receiving the function key L (thumb LD) and the numeric keys 1 and 2, the calculator 53 identifies and executes deletion of clauses which have been input so far. Furthermore, when receiving the function key L (thumb LD) and the numeric keys 1, 2, and 3, the calculator 53 identifies and executes deletion of all documents which have been input so far. Still further, when receiving the function key R (thumb RD) and the numeric keys 1, 2, and 3, the calculator 53 identifies and executes the reading of all the documents which have been input so far.

[Effects of Finger-Braille System 1B]

The finger-braille system 1B has the following effects in addition to the same effects as the finger-braille system 1A.

The finger-braille system 1B is based on the assumption that four fingers including the thumb of each hand are used, so that it is possible to efficiently operate a smartphone and also implement functional processing other than characters.

Furthermore, the first holding portions 21A to 21D of the finger-braille system 1B each have a ring-like shape. Therefore, even if the wearer's fingers vary considerably in thickness and length, by forming the first holding portions 21A to 21D of an elastic material, it is possible to easily wear the first holding portions 21A to 21D while reducing the burden on the wearer. Moreover, the manufacturing cost thereof can be suppressed to the minimum level.

Although the embodiments of the present invention have been described above, in addition to the foregoing, it is possible to select some of the configurations mentioned in the above embodiments or change them to other configurations as appropriate without departing from the gist of the present invention.

The above finger-braille system 1 has been described on the premise that it is used in a Japanese environment. However, Braille is used in many countries around the world, and by incorporating their conversion tables into the software of the present device, visual and auditory disabled people around the world can easily use the present device by learning the finger-braille input method.

Additionally, if a visual and auditory disabled person has a trouble in any of the index finger, the middle finger, or the ring finger, the device can be used by transferring the input/output unit to another finger or by shifting the vibration position forward or backward in the longitudinal direction of the finger.

The wearing side devices 3A and 3B can transmit character information in sign language in addition to braille information by using the motion detector 13 consisting of a three-axis acceleration sensor. In other words, a secondary feature of the three-axis acceleration sensor is that it can read three-dimensional waveforms, and this conversion mechanism can also be applied to character conversion of sign language information. For example, character input/output and deletion works such as character conversion of “yes” and “no” and a deletion work of mistyped finger-braille can be performed by sign language easier than inputting based on finger-braille or motions based on sign language. In recent years, the analysis ability of a three-dimensional waveform reading technique has been greatly improved through methods such as machine learning, so that if it becomes possible to sufficiently enhance the literacy rate of three-dimensional waveforms in the future, from viewpoint of wearers, it would be possible for the wearers to use the wearing side devices 3A and 3B as devices for inputting both sign language and finger-braille information and outputting corresponding character information. Furthermore, as an application of this technique, in the transmission of finger-braille information, the devices are not used for dot waveforms on a fixed surface, but used for waveform recognition in three-dimensional space without tapping a fixed surface, which makes it possible to use the devices in a wider range of environments. These series of programs can be installed and used on smartphones and personal computers as application software.

In the present embodiment, the three-axis acceleration sensor is used as the motion detector 13. However, the three-axis acceleration sensor is only an example of the motion detection means, and the present invention can use other sensors capable of detecting the motions of fingers such as an optical sensor, a strain sensor, and a myoelectric potential sensor. These sensors can detect the motions of fingers without applying any external force other than finger motion.

A metal ring, a water-repellent resin or the like which does not get wet with liquid such as water or alcohol may be used as the first holding portion 21 of the wearing side devices 3A and 3B. Even when the metal ring or the water-repellent resin ring is used as the first holding portion 21, the method of fixing the input/output unit 10 basically follows the method illustrated in FIG. 4. Furthermore, a three-dimensional modeling method may be also adopted to manufacture the wearing tool 20.

As described above, quick-drying fabrics are effective in restraining the outbreak of viruses and bacteria, but using materials having surfaces that exhibit an antibacterial effect and an antiviral effect are more actively used, whereby it is possible to more actively take countermeasures for enabling wearers to protect their bodies from the harm of viruses and bacteria, and preventing the spread of infection. For example, materials for wearing can be selected from among chemical fibers shown in antimicrobial and deodorant/antibacterial chemical fibers lists published on the website of the Japan Chemical Fibers Association. Furthermore, it is possible to adopt a structure in which the wearing material is coated with an antibacterial coating by applying a solution having antimicrobial and antibacterial effects such as titanium oxide nanoparticle liquid or the like.

### REFERENCE SIGNS LIST

1A, 1B finger-braille system
3A, 3B wearing side device
5 non-wearing side device
10, 10A, 10B, 10C input/output unit
11 vibrator
13 motion detector
15 transceiver
20 wearing tool
21, 21A, 21B, 21C first holding portion, first holding portion
22A, 22B, 22C pocket
22ᵢₙ inner layer
22ₒᵤₜ outer layer
23 second holding portion
23A holding portion
23ᵢₙ inner layer
23ₒᵤₜ outer layer
23B first connecting portion
23C second connecting portion
23D pocket
25 band
25A, 25B end portion
30, 30A, 30B, 30C signal cable
50 main body unit
51 first transceiver
53 calculator
55 command unit
57 second transceiver
61 transceiver
63 input unit
65 display unit
67 controller
110 radio communication
LH left hand
RH right hand
B back of hand
F finger
R wrist
FA, LA, RA index finger
FB, LB, RB middle finger
FC, LC, RC ring finger
LD, RD thumb
FN fingernail
FP1, FP2, FP3 finger pad
J1 first joint
J2 second joint
J3 third joint

1. A finger-braille-device capable of performing wireless transmission and reception with an external smartphone or personal computer comprising:
an input/output unit for transmitting motion information based on a finger-braille motion signal of each finger, and receiving vibration information related to finger-braille to each finger to transfer vibration to each finger;
a main body unit for receiving the motion information from the input/output unit to perform predetermined processing, and transmitting the vibration information to the input/output unit; and
a wearing tool for wearing the input/output unit on a back side of each finger and wearing the main body unit on a back of a hand,
wherein the input/output unit comprises:
a transceiver that is provided on a back side of each finger of the hand by the wearing tool, and performs transmission and reception with the main body unit;
a motion detector that detects a signal complying with the motion of each finger and transmits the signal as motion information of each finger to the main body unit via the transceiver; and
a vibrator that transfers vibration to a pre-assigned finger based on the vibration information received from the main body unit via the transceiver,
wherein the main body unit comprises a first transceiver that performs transmission and reception with the input/output unit, and a second transceiver that performs wireless transmission and reception with an outside, and
wherein based on motion information complying with the motion of the finger received via the first transceiver and detected by the motion detector, the main body unit identifies character information regarding finger-braille and/or function information to be executed, wirelessly transmits the character information and/or the function information via the second transceiver to an outside, and
transmits vibration information to be assigned to each finger via the first transceiver based on character information regarding finger-braille and command information received from the outside via the second transceiver.

2. The finger-braille device capable of performing wireless transmission and reception with an external smartphone or personal computer according to claim 1,
wherein the main body unit is provided in advance with association information for associating the motion information with the character information to be identified and/or function information to be executed,
collates the motion information received from the first transceiver of the input/output unit with the association information, thereby converting the motion information to and identifying the character information regarding finger-braille and/or function information to be executed, and wirelessly transmits them to an outside by the second transceiver.

3. The finger-braille device capable of performing wireless transmission and reception with an external smartphone or personal computer according to claim 1,
wherein the motion detector comprises a three-axis acceleration sensor that detects three-dimensional waveform information of a motion of each finger, and transmits motion information corresponding to the detected three-dimensional waveform information to the first transceiver of the input/output unit, and the transceiver transmits the motion information to the main body unit.

4. The finger-braille device capable of performing wireless transmission and reception with an external smartphone or personal computer according to claim 1,
wherein the main body unit transmits, from the first transceiver, vibration information assigned to each finger based on finger-braille information from an outside that is received by the second transceiver of the main body unit, and
the vibrator comprises an eccentric vibration motor or a piezoelectric actuator for vibrating each assigned finger based on the vibration information received from the main body unit via the first transceiver of the input/output unit.

5. The finger-braille device capable of performing wireless transmission and reception with an external smartphone or personal computer according to claim 2,
wherein the motion detector comprises a three-axis acceleration sensor that detects three-dimensional waveform information of a motion of each finger, and transmits motion information corresponding to the detected three-dimensional waveform information to the first transceiver of the input/output unit, and the transceiver transmits the motion information to the main body unit.

6. The finger-braille device capable of performing wireless transmission and reception with an external smartphone or personal computer according to claim 2,
wherein the main body unit transmits, from the first transceiver, vibration information assigned to each finger based on finger-braille information from an outside that is received by the second transceiver of the main body unit, and
the vibrator comprises an eccentric vibration motor or a piezoelectric actuator for vibrating each assigned finger based on the vibration information received from the main body unit via the first transceiver of the input/output unit.

7. The finger-braille device capable of performing wireless transmission and reception with an external smartphone or personal computer according to claim 3,
wherein the main body unit transmits, from the first transceiver, vibration information assigned to each finger based on finger-braille information from an outside that is received by the second transceiver of the main body unit, and
the vibrator comprises an eccentric vibration motor or a piezoelectric actuator for vibrating each assigned finger based on the vibration information received from the main body unit via the first transceiver of the input/output unit.
